(19) United States
(12) Patent Application Publication
(10) Pub. No.: US 2017/0315564 A1
(43) Pub. Date: Nov. 2, 2017

(54) A METHOD AND APPARATUS FOR ADJUSTING DRAG ON A TRAILING AIR VEHICLE FLYING BEHIND A LEADING AIR VEHICLE

(71) Applicant: OXFORD UNIVERSITY INNOVATION LIMITED, Botley, Oxford (GB)

(72) Inventors: Adrian L. R. THOMAS, Botley (GB); Graham K. TAYLOR, Botley (GB)

(21) Appl. No.: 15/522,209

(22) PCT Filed: Oct. 27, 2015
(86) PCT No.: PCT/GB2015/053225

§ 371 Date: Apr. 26, 2017

(30) Foreign Application Priority Data
Oct. 30, 2014 (GB) 1419356.9

(51) Int. Cl. G05D 1/10; B64C 13/18; G06T 7/73; B64C 39/02; B64D 47/08

(52) U.S. Cl. CPC G05D 1/104; B64C 39/024; B64D 47/08; G06T 7/74; B64C 13/18; G06T 2207/30248

(57) ABSTRACT

A method of adjusting the drag on a trailing air vehicle (3) flying behind a leading air vehicle (1), the method comprising the steps of: (i) detecting a wingtip vortex (5) shed from the leading air vehicle (1), for example using background oriented schlieren; (ii) determining the position of the wingtip vortex (5) for example using photogrammetry; and (iii) modifying the flight path of the trailing air vehicle (3) in dependence on the determined position. This may enable the trailing air vehicle (3) to efficiently interact with the wingtip vortex (5) and reduce drag.

### TECHNICAL FIELD

The present invention relates to methods and apparatus for adjusting drag on an air vehicle. More particularly, but not exclusively, the invention relates to methods and apparatus for reducing drag on a trailing air vehicle, by efficient interaction with wing tip vortices from a leading air vehicle.

### BACKGROUND OF THE INVENTION

It is often desirable to minimise drag on air vehicles. A reduction in drag can enable the air vehicle to carry a lower fuel load, or more commonly it allows an air vehicle to fly a longer mission on the same fuel load. A military air vehicle such as an unmanned air vehicle (UAV) may, for example, be able to spend longer in a combat zone, or in a holding location outside a combat zone. Drag reduction also has financial benefits, especially for commercial passenger aircraft in terms of reduced fuel consumption.

When a plurality of air vehicles fly in relatively close proximity, it is well known that the position of the trailing air vehicle relative to the leading air vehicle, can have a significant impact on the drag experienced by the trailing air vehicle. In particular, if the trailing air vehicle flies in an appropriate position with respect to one of the wing tip vortices shed from the leading air vehicle, such that it experiences an up-wash, the trailing air vehicle tends to experience a corresponding reduction in drag.

Aircraft incorporating drag reduction systems which seek to take advantage of this phenomenon have been suggested. In these suggested systems, the location of a wing tip vortex (from a leading aircraft) is predicted based on the relative position of the lead aircraft, for example using computational fluid dynamics (CFD) modelling. The flight path of the trailing aircraft is modified in dependence on the predicted location of the vortex, in an attempt to minimise drag. A problem with such a system is that the location of a vortex can be sensitive to variables such as air turbulence, aircraft configuration, aircraft flight speed and aircraft loading, which may not be computed by the predictive model. Furthermore, the predictive model may have some inherent limitations in modelling a real-world flow. The predicted location of the vortex is therefore not necessarily the same as the true location of the vortex. The trailing aircraft is therefore not necessarily flying in the most efficient position.

It is desirable to provide a method and system that removes, or mitigates, at least some of the above-mentioned problems.

### SUMMARY OF THE INVENTION

According to a first aspect of the invention, there is provided a method of adjusting the drag on a trailing air vehicle flying behind a leading air vehicle, the method comprising the steps of:

(i) detecting a wingtip vortex shed from the leading air vehicle;

(ii) determining the position of the wingtip vortex; and

(iii) modifying the flight path of the trailing air vehicle in dependence on the determined position,

thereby enabling the trailing air vehicle to efficiently interact with the wingtip vortex.

The present invention recognises that by detecting the wingtip vortex, and determining its position, the trailing air vehicle is able to extract maximum benefit from the vortex. More specifically, the present invention enables the air vehicle to more efficiently interact with the vortex, because its flight path is modified in dependence on the actual location of the vortex (rather than just a predicted location).

The method may, in principle, be used to adjust the flight path in any way, in response to the position of the vortex being determined. For example it may be used to actively avoid the vortex (for example to avoid turbulence), which may mean the air vehicle experiences an increase in drag (relative to a more efficient interaction with the vortex). More preferably however, the method is a method of reducing drag (by efficiently interacting with the vortex).

The detection of the wingtip vortex may, in principle, be achieved in a number of different ways. For example, the vortex may be detected using a background oriented schlieren technique. The vortex may be detected using thermal/IR imaging. The vortex may be detected using LiDAR.

In preferred embodiments of the invention, the detecting of the vortex is achieved by imaging the vortex. The step of imaging the wingtip vortex may comprise capturing an image ahead of the trailing air vehicle. The image may be an image of a field of view (FOV) ahead of the vehicle. It will be appreciated that ‘ahead’ merely refers to any location forward of the trailing air vehicle and need not necessarily be parallel to the direction of travel of the trailing air vehicle. For example, the FOV may be slightly above (and ahead of) or below (and ahead of) the trailing air vehicle.

In some embodiments of the invention, the vortex may be readily identifiable directly from the image. For example the image may be a thermal image and the vortex may be readily identifiable from thermal gradients in the image. However, in preferred embodiments of the invention, the step of imaging the wingtip vortex also comprises processing the image to identify the vortex in the FOV. For example the vortex may not necessarily be identifiable from the image per se, and it may be necessary to process the image in order to identify the vortex.

The method preferably comprises capturing a multiplicity of images. The multiplicity of images may be of the same FOV. The multiplicity of images may be of different FOVs. The multiplicity of images may be processed to identify the vortex. The multiplicity of images are preferably processed using a background oriented schlieren technique. Using background oriented schlieren techniques to detect changes in air flow is known per se (for example see DE19942856A1). Using a background oriented schlieren technique has been found to be especially beneficial in embodiments of the present invention because it enables the vortex to be imaged relatively easily and with relatively simple equipment. For example using a background oriented schlieren technique does not require an image capture device that operates outside the visible spectrum; it can be used in conjunction with a relatively simple camera which captures images in the visible spectrum. Furthermore the background oriented schlieren technique only requires relatively simple image processing software. In contrast to some other approaches, for example using LiDAR, background oriented schlieren is also a ‘passive’ technique (it does not therefore require any active interrogation of the vortex in order to detect that vortex).

The background oriented schlieren technique typically requires a textured background in order to identify movement of air (for example the vortex) in the foreground. Clouds, stars or other variation in the sky may provide sufficient texture, but in some embodiments, the FOV is directed below the horizon such that there is reliably a textured background (from the ground or sea).

The method may comprise the step of determining the rotational direction of the vortex. The rotational direction may be determined from an image for detecting the vortex. The step of determining the rotational direction of the vortex may comprise detecting both wing tip vortices from the leading aircraft and determining the rotational direction of one, from its position relative to the other.

To efficiently interact with a vortex it is necessary to not only detect it, but to also determine its position. In some embodiments the step of determining the position of the vortex, may be simultaneous with the step of detecting the vortex. For example, a LiDAR-based system may be arranged to detect the vortex and simultaneously determine its position.

In preferred embodiments of the invention, the position of the vortex is determined using a photogrammetric technique. Using photogrammetry has been found to be especially beneficial in embodiments in which the vortex is imaged, because it (re)uses the captured image(s) of the vortex. It does not, therefore, require any additional hardware and is a relatively simple and efficient way of determining the vortex position.

The position of the vortex is preferably the position of the vortex in 3D space. In some embodiments of the invention, the position of the vortex is the position relative to the trailing air vehicle. In some embodiments of the invention, the position of the vortex is the absolute position.

In principle, the flight path of the air vehicle may be modified by a pilot directly (for example via a manual control in response to an indication of the vortex position). More preferably, the flight path is automatically modified by a flight control module. The flight control module may, for example, be linked to an auto-pilot of the air vehicle.

According to another aspect of the invention, there is provided an air vehicle comprising a drag adjustment system, the system comprising:

a vortex detection module configured to detect a wingtip vortex ahead of the air vehicle; and

a vortex position-determining module configured to determine the position of the wingtip vortex

thereby enabling the flight path of the air vehicle to be altered to ensure it efficiently interacts with the wingtip vortex.

By providing the detection module and vortex positioning module, the position of the vortex can be accurately determined, and the air vehicle can be manoeuvred accordingly.

The system may further comprise a flight control module configured to automatically modify the flight path of the air vehicle in dependence on the output of the vortex position-determining module.

The air vehicle may comprise an image capture device. The image capture device may have a field of view (FOV) directed ahead of the air vehicle.

The location of the FOV may be adjustable. The air vehicle may comprise a position-estimating module for estimating the position of the vortex. The location of the FOV may be adjusted in dependence of the estimated position of the vortex, such that the FOV is directed to that estimated position. Such an arrangement has been found to be particularly beneficial because it increases the likelihood of the vortex being in the FOV. The air vehicle may be arranged to determine the location of the FOV relative to the aircraft; such an arrangement is especially beneficial in embodiments in which the location of the FOV may be adjusted.

The image capture device is preferably arranged to capture an image of the FOV. The image capture device may be arranged to capture images in the non-visible spectrum (for example an IR image capture device), but more preferably the image capture device is arranged to capture images in the visible spectrum. The image capture device may be a camera. The image capture device may be arranged to capture a multiplicity of images. The multiplicity of images may be sequential in time.

The system may comprise an image stabiliser. The image stabiliser may be in the form of hardware (for example a gimballed mount for the image capture device). The image stabiliser may be in the form of software (for example image processing software).

The air vehicle may comprise an image processor arranged to process the image to identify the vortex. The image processor may be configured to identify the vortex using a background oriented schlieren technique.

The air vehicle may comprise a plurality of image capture devices. Each image capture device may have a field of view (FOV) directed ahead of the air vehicle and each image capture device may be arranged to capture an image of the respective FOV. The FOVs preferably overlap. The image capture devices are preferably located on the air vehicle at locations that are spaced apart from one another. For example the image capture devices may be located on different respective wings of the air vehicle. Having a plurality of image capture devices is beneficial because it enables the vortex to be identified from at least two different images. Where those images are captured from different locations (e.g. where the image capture devices are spaced apart from one another) this may facilitate a relatively straightforward determination of the position of the vortex. The vortex position-determining module is preferably configured to determine the position of the wingtip vortex using a photogrammetric technique. The photogrammetric technique preferably uses the images captured from each of the plurality of image capture devices.

The detection module may be an imaging module. The imaging module may comprise the image capture device(s). The imaging module may comprise the image processor.

It will be appreciated that reference herein to a ‘module’ encompasses any part of the system that is capable of performing the required function. For example, the module may be a self-contained unit. The module may be a plurality of sub-units distributed throughout the system.

In principle, the present invention is applicable to any air vehicle. The air vehicle is preferably a fixed-wing air vehicle. The invention is particularly beneficial for air vehicles that tend to fly in formation. For example the air vehicle may be a military air vehicle. The air vehicle may be unmanned (e.g. a UAV), or may be manned (for example a fighter aircraft). Aspects of the present invention are also applicable to commercial air vehicles, such as passenger aircraft. Even though passenger aircraft do not fly in formation as such, they do tend to follow narrow air space channels and thus they may be able to take advantage of the invention described herein to increase fuel efficiency.

According to another aspect of the invention, there is provided a drag adjustment system for use on the air vehicle described herein. The drag reduction system may comprise:

a vortex detection module configured to detect wingtip vortices ahead of the air vehicle; and

a vortex position-determining module configured to determining the position of the wingtip vortex. The drag adjustment system is preferably a drag reduction system.

According to yet another aspect of the invention, there is provided a computer program product arranged, when executed upon one or more processors, to perform steps (i) and (ii) of the method described herein. According to yet another aspect of the invention, there is provided a computer program product arranged, when executed upon one or more processors of a wingtip vortex detection module and a vortex position-determining module, to provide a drag adjustment system as described herein.

Any features described with reference to one aspect of the invention are equally applicable to any other aspect of the invention, and vice versa. For example, any features described with reference to the method of the invention may be applicable to the apparatus of the invention, and vice versa.

### DESCRIPTION OF THE DRAWINGS

Various embodiments of the invention will now be described, by way of example only, with reference to the accompanying schematic drawings.

FIG. 1 is a schematic of leading aircraft and a trailing aircraft incorporating a drag reduction system according to a first embodiment of the invention; and

FIG. 2 is a schematic showing the drag reduction system on the trailing aircraft of FIG. 1.

### DETAILED DESCRIPTION

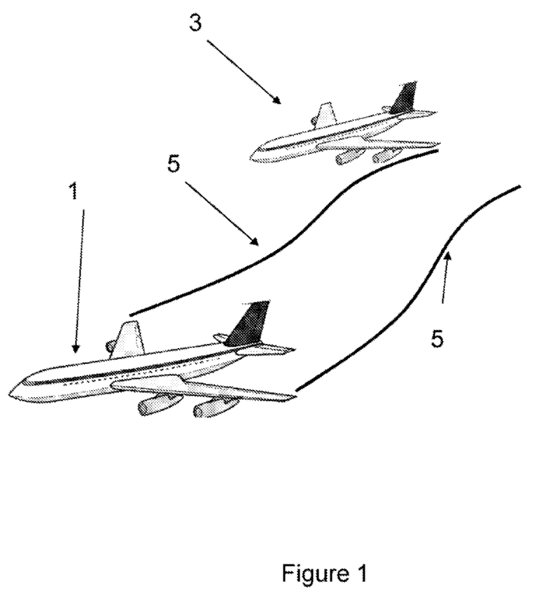

FIG. 1 shows a leading aircraft 1 and a trailing aircraft 3 flying behind the leading aircraft 1. The leading aircraft generates wing tip vortices 5, which are shed from the wing tips during flight. Although the wing tip vortices 5 are illustrated in FIG. 1 for clarity, they are often difficult, if not impossible, to see with the naked eye.

It is well known that the position of the trailing aircraft 3 relative to the leading aircraft 1, has a significant impact on the drag experienced by the trailing aircraft 3. In particular, if the trailing aircraft 3 flies with a wing tip in one of the wing tip vortices 5 shed from the leading aircraft 1, such that it experiences an up-wash, the trailing aircraft 3 tends to experience a corresponding reduction in drag.

Aircraft incorporating drag reduction systems which seek to take advantage of this phenomena have been suggested. In these suggested systems, the location of a wing tip vortex (from a leading aircraft) is predicted using a theoretical model such as may be implemented using computational fluid dynamics (CFD) modelling. The flight path of the trailing aircraft is modified in dependence on the predicted location of the vortex, in an attempt to minimise drag. A problem with such a system is that the location of a vortex can be sensitive to variables such as air turbulence, aircraft configuration, aircraft flight speed and aircraft loading, which may not be computed by the predictive model. Furthermore, the predictive model may have some inherent limitations in modelling a real-world flow. The predicted location of the vortex is therefore not necessarily the same as the true location of the vortex. The trailing aircraft is therefore not necessarily flying in the most efficient position.

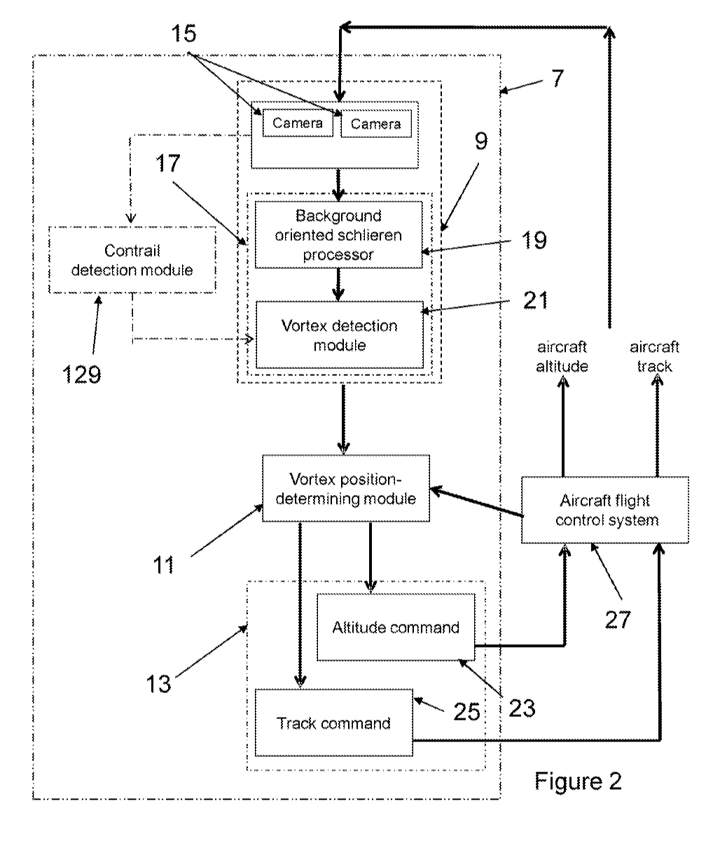

The trailing aircraft 3 in FIG. 1 incorporates a drag reduction system 7 (not visible in FIG. 1) which seeks to overcome the above-mentioned problem. That system 7 will now be described with reference to FIG. 2.

The drag reduction system comprises an imaging module 9, a vortex position-determining module 11, and a flight control module 13.

The imaging module 9 is configured to detect a vortex 5 generated by the leading aircraft 1. The imaging module 9 comprises two optical cameras 15, each mounted on the tip of a respective wing of the trailing aircraft 3. The cameras 15 are each configured to sequentially capture a multiplicity of images. Each camera has a field of view (FOV). In the first embodiment of the invention, the FOV of each camera is fixed and is orientated ahead of the aircraft 3 and slightly downwards such that it will cover the most likely location of a wing tip vortex from the leading aircraft 1. The FOVs substantially overlap. By orientating the FOVs slightly downward, each FOV is likely to have ground/sea in the background which may assist in imaging the vortex using the background oriented schlieren technique (discussed in more detail below).

The cameras 15 are arranged to continuously capture images of their respective FOVs. Those images are then received by image processing module 17. The image processing module 17 comprises a background oriented schlieren software unit 19 configured to identify a vortex in the images using a background oriented schlieren technique.

Background oriented schlieren techniques are known per se. Broadly speaking the technique involves measuring distortion in one image relative to another image to assess the refraction of light caused by changes in air density. Background oriented schlieren uses cross-correlation image analysis techniques to detect differences between the two images.

The first embodiment of the invention recognises that at typical aircraft cruising Mach numbers, there is a detectable difference in air density between the core of a wingtip vortex and ambient and that this difference will result in changes to the refraction of light that can be detected by background oriented schlieren. This therefore allows images of the wingtip vortex to be formed.

Referring back to FIG. 2, the background oriented schlieren software unit 19 processes the images from the cameras 15 in the above-described manner, and generates a series of output images revealing at least one vortex in the FOV. A further software module 21 then receives the output images and identifies and labels the vortex, together with an indication of its rotational direction (dependent on which wingtip of the leading aircraft is originated from).

The imaging module 9 thus outputs images, each based on an image from a respective cameras 15, showing the vortex from the leading aircraft in that camera's FOV. Since there are two cameras 15, two images of the vortex are obtained at any one time, each image being from a different reference point (the opposing wings of the trailing aircraft 3). The first embodiment of the invention uses a vortex position-determining module 11 to use these images to determine the actual position of the vortex 5 relative to the trailing aircraft 3.

In the first embodiment of the invention, the vortex position-determining module 11 uses photogrammetry to calculate the position of the vortex 5 in 3D space relative to the trailing aircraft 3. Photogrammetry has been found to be a particularly attractive method of determining the vortex position because it uses the images already processed and output from the imaging module 9, and more specifically the images generated using the background oriented schlieren technique. The use of both background oriented schlieren and photogrammetry in combination has therefore been found to be particularly efficient and simple.

The position-determining module 11 is arranged to output the position of the vortex 5 to a flight control module 13. The flight control module 13 is similar to known flight control modules in that it comprises an altitude command unit 23 (for generating altitude control signals) and a track command unit 25 (for generating track control signals). The flight control module is operatively linked to the aircraft central flight control system 27 which is configured to adjust the aircraft altitude and aircraft track in dependence on the output of the flight control module 13. The altitude and track command units 23, 25 of the flight control module 13 are configured to output commands such that the longitudinal axis of the aircraft 3 is substantially parallel to the imaged vortex 5 from the leading aircraft 1, and the inner-most wing tip of the trailing aircraft 3 (i.e. the left-hand wingtip in FIG. 1) is placed approximately in the core of that vortex 5 (which had already been identified as being from the right-hand wing tip of the leading aircraft). This position provides optimum up-wash for the trailing aircraft and maximum drag reduction (and therefore enables maximum fuel efficiency). The change in position of the trailing aircraft may, in turn, change the position of the camera FOVs (see large arrow in FIG. 2 linking output of aircraft altitude and track, to the input to the system 7).

The aircraft flight control system 27 also communicates with the vortex position-determining module 11. This enables the absolute location of the vortex 5 to be determined because the aircraft flight control system 27 is able to access data relating to the absolute location of the aircraft (e.g. data relating to GPS position, orientation, heading, and drift of the aircraft). This is beneficial when autopilot is being used, because autopilot tends to operate based on absolute position data, rather than only relative positioning.

It will be appreciated from the above-description, that the first embodiment of the invention thus provides a system and method of reducing drag, which accurately detects the vortex and determines its position. This preferably mitigates at least some of the problems of the previously suggested arrangements in which the vortex position is predicted.

According to a second embodiment of the invention, the drag reduction system also comprises a condensation trail (contrail) detection module 129 (shown in phantom in FIG. 2). The contrail detection module 129 detects the condensation trails of the leading aircraft. These are used to determine the approximate likely location of the wing tip vortices. In the second embodiment of the invention, the output of the contrail detection module 129 is received by the vortex detection module 21; the contrail detection module is used in combination with a theoretical model (not shown) to compute a prior probability distribution for the expected location of the tip vortex, to assist the vortex detection module in detecting the vortex. In a further embodiment (not shown) the output of the contrail module is linked to the cameras, which are pivotably mounted on the aircraft. The orientation of the cameras is adjusted such that their FOVs are directed to the contrail, thereby increasing the likelihood of a vortex being within the cameras' FOV.

The first and second embodiments of the invention use passive vortex detection by imaging the FOV ahead of the aircraft. A further embodiment (not shown) uses thermal imaging cameras to detect the vortex (the vortex having a temperature gradient across it). Yet another embodiment (not shown) uses an active detection method comprising LiDAR, The trailing aircraft comprises a laser for emitting ahead of the trailing aircraft and a LiDAR detector for detecting the vortex and its position, based on reflections/scattering of the laser by the vortex. In all the above-mentioned embodiments, it will be appreciated that the drag reduction system detects the actual vortex. Each of the drag reduction systems therefore tends to provide improved performance over previously-suggested systems in which the vortex location is estimated using a theoretical model.

In yet another embodiment (not shown) the trailing aircraft only comprises a single camera for capturing the image of the FOV. The position-determining module uses photogrammetric techniques, but instead of using images from the two different cameras, it uses sequential images from the same camera, in conjunction with data on the different position of the aircraft, at each moment the images were taken. In a variant of the above-mentioned embodiment, the aircraft comprises an additional camera, for use in detecting the vortex (for example to obtain a tare image for use in a background oriented schlieren technique), but the photogrammetric technique used to determine the position of the vortex still only uses the output of the single camera.

Whilst the present invention has been described and illustrated with reference to particular embodiments, it will be appreciated by those of ordinary skill in the art that the invention lends itself to many different variations not specifically illustrated herein. For example, the cameras need not necessarily be located on the wings of the trailing aircraft; they may be located elsewhere such as the fuselage and/or tail plane.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A method of adjusting the drag on a trailing air vehicle flying behind a leading air vehicle, the method comprising the steps of:
(i) detecting a wingtip vortex shed from the leading air vehicle;
(ii) determining the position of the wingtip vortex; and
(iii) modifying the flight path of the trailing air vehicle in dependence on the determined position,
thereby enabling the trailing air vehicle to efficiently interact with the wingtip vortex.

2. A method according to claim 1 wherein the step of detecting comprises capturing an image of a field of view (FOV) ahead of the trailing air vehicle.

3. A method according to claim 2 wherein the method comprises processing the image to detect the vortex in the FOV.

4. A method according to claim 3, comprising capturing a multiplicity of images, and processing the images to identify the vortex using a background oriented schlieren technique.

5. A method according to claim 1, wherein the position of the vortex, is determined using a photogrammetric technique.

6. A method according to claim 1, wherein the flight path is automatically modified by a flight control module.

7. An air vehicle comprising a drag adjustment system, the system comprising:
a vortex detection module configured to detect a wingtip vortex ahead of the air vehicle; and
a vortex position-determining module configured to determine the position of the wingtip vortex
thereby enabling the flight path of the air vehicle to be altered to ensure it efficiently interacts with the wingtip vortex.

8. An air vehicle according to claim 7, wherein the system further comprises a flight control module configured to automatically modify the flight path of the air vehicle in dependence on the output of the vortex position-determining module.

9. An air vehicle according to claim 7 comprising an image capture device, wherein the image capture device has a field of view (FOV) directed ahead of the air vehicle and the image capture device is arranged to capture an image of the FOV.

10. An air vehicle according to claim 9, comprising an image processor arranged to process the image to detect the vortex.

11. An air vehicle according to claim 10, wherein the image capture device is arranged to capture a multiplicity of images of the FOV, and the image processor is configured to process the images to identify the vortex using a background oriented schlieren technique.

12. An air vehicle according to claim 9, comprising a plurality of image capture devices, wherein each image capture device has a field of view (FOV) directed ahead of the air vehicle and each image capture device is arranged to capture an image of the respective FOV.

13. An air vehicle according to claim 7, wherein the vortex position-determining module is configured to determine the position of the wingtip vortex using a photogrammetric technique.

14. An air vehicle according to claim 13, wherein the photogrammetric technique uses the images captured from each of the plurality of image capture devices.

15. An air vehicle according to claim 7, wherein the air vehicle is a UAV.

16. An air vehicle according to claim 7, wherein the air vehicle is a manned aircraft.

17. A drag adjustment system for use on the air vehicle according to claim 7, the drag reduction system comprising:
a vortex detection module configured to detect wingtip vortices ahead of the air vehicle; and
a vortex position-determining module configured to determining the position of the wingtip vortex.

18. A drag adjustment system according to claim 17, wherein the system comprises an image capture device for capturing
an image, and an image processor for processing the image such that the wingtip vortex can be identified in the image.

19. A computer program product arranged, when executed upon one or more processors, to perform steps (i) and (ii) of the method according to claim 1.

20. A computer program product arranged, when executed upon one or more processors of a wingtip vortex detection module and a vortex position-determining module, to provide a drag adjustment system according to claim 17.
